(19) United States
(12) Patent Application Publication
(10) Pub. No.: US 2008/0189402 A1
(43) Pub. Date: Aug. 7, 2008

(54) Method and Respective System for Performing Systems Management on IT-Resources Using Web Services

(75) Inventors: Boas Betzler, Magstadt (DE); Dietmar Kuebler, Aldorf (DE); Georg Ochs, Moetzingen (DE)

Correspondence Address: IBM CORPORATION;ROCHESTER IP LAW DEPT. 917, 3605 HIGHWAY 52 NORTH, ROCHESTER, MN, 55901-7829, US

(73) Assignee: INTERNATIONAL BUSINESS MACHINES CORPORATION, Armonk, NY (US)

(21) Appl. No.: 11/836,932

(22) Filed: Aug. 10, 2007

(30) Foreign Application Priority Data
Feb. 6, 2007 (DE) 07101770.1

(51) Int. Cl. G06F 15/173

(52) U.S. Cl. 709/223

(57) ABSTRACT

The present invention relates to performing systems management on IT-resources using web services, wherein the resources are managed in a computational network within a plurality of runtime environments having different respective instrumentations, wherein the web services are implemented according to a public web service standard, and wherein a resource configuration database is provided for storing a collection of resource-specific data on said IT-resources. In order to to provide an improved method and system for an implementation of dynamic extensibility with instrumentation capabilities the following steps are performed: server-side correlating the network address of a resource comprised of said network with a database entry provided within said configuration database for said resource, wherein said correlation includes the definition of an instrumentation of said resource, selecting said entry for automatically invoking the instrumentation of said resource, accessing said resource via a web service by using said automatically invoked resource instrumentation.

### BACKGROUND OF THE INVENTION

1. Field of the Invention

The present invention relates to the field of systems management. In particular, it relates to a method and respective system for performing systems management on IT-resources using web services, wherein the resources are managed in a computational network within a plurality of runtime environments having different respective instrumentations, wherein the web services are implemented according to a public web service standard, e.g., WSDM, and wherein a resource configuration database is provided for storing a collection of resource-specific data on said IT-resources.

2. Description and Disadvantages of Prior Art

The background underlying to the present invention is dominated by the basic mechanisms of applying web services technology to existing products and technology of systems management, by leveraging as much as possible their existing capabilities.

The main components of these mechanisms are WSDM-enabled instrumented resources, a configuration database used as a registry that has WSDM interfaces, a message infrastructure enabled by a notification broker to support events, and a management application exploiting WSDM.

Web services (WS) standards such as WSDM and WS-Management and future converged standards describe how IT resources (operating systems, printers, applications, etc.) expose their manageability capabilities using web services to client applications. These client applications typically are systems management applications provided by IBM, or by Internet Service Providers (ISVs), or 3rd party vendors. Prior art web services describe their interfaces in XML documents following the WSDL standard. They are accompanied by implementations of the respective web services typically being deployed and executed on application servers.

Next, a comprehensive summary of prior art processes in the field of web services based systems management is given. Reference is made to FIG. 1A:

Time-based discovery gathers information about network attached IT resources and stores it in TADDM (Tivoli Application Distributed Discovery Manager (TADDM)/Configuration Management Database (CMDB). Typically these are long-running, scheduled activities that require a lot of compute resources.

Multiple discovery runs require a correlation component ensuring that new data is inserted, or already existing data is updated.

Management Applications query Meta data (Web Services Description Language (WSDL), RMD), enumerate CMDB classes, enumerate instances of a particular class and follow the relationships of the entities. They access entries in TADDM/CMDB as WSDM manageable resources. They can subscribe to events issued by the TADDM/CMDB to the Notification Broker. Enabling to do this using WSDM, is achieved using a set of web services called WSDM common services (WSDM CS).

Resources with applied instrumentation capabilities such as Computer Information Model (CIM), Simple Network Management Protocol (SNMP), or Java Management Extension (JMX) are WSDM-enabled using a set of web services called WSDM CS for instrumented Resources. These resources emit life cycle events such as created or destroyed to the notification broker. This gives the ability for short-running, real-time discovery as well as other capabilities such as providing data to subscribers that is not stored in the configuration database. Typically, this would be monitoring data like CPU load, number of active OS processes, and the like.

Given such an IT Resource advertises it's presence in the network through a life cycle event, the Correlation component needs to check, if the data representation of the resource is already in the database found earlier by for example time-based discovery runs. If not, an entry is created in the database. In both cases a relationship is established in the database that links the data entry with the Instrumented Resource. This enables clients to query the data representation and get access to the associated instrumented resources as well.

Multiple such relationships can be associated to the data entry.

The complexity of the correlation functionality varies with the underlying models of the instrumented resources and the representation in CMDB. The straightforward case is, when both have the same underlying model. In case they differ, policies need to be defined to allow identifying if the data representation in TADDM/CMDB is the one representing the Instrumented resource.

Then it is possible to actually do systems management with the Instrumented Resource e.g., issuing a command.

With particular focus to the present invention the above mentioned systems management applications typically require access to data that is collected on a timely basis, e.g., by above mentioned discovery mechanisms and stored in configuration databases such as CMDB. This kind of data is required to get access to information such as IP address, hostname, etc. In order to really manage the resources, operational data is required as well and commands need to be passed to the resource. For example the resource to be accessed by a web service is an operating system, and the systems management primary function is assumed to monitor the CPU load thereof.

In order to extend existing manageable resources stored in CMDB with instrumented manageable resources, relationships with special semantics can be used. One such “artificial” relationship has been proposed as “InstrumentedBy”. A typical example for the usage of such a relationship is an instrumented manageable resource such as an agent providing for example the above mentioned monitoring capabilities. This agent can be assumed to be installed on top of an operating system. Further, the operating system can have multiple InstrumentedBy-relationships to respective multiple instrumentations. This behavior is also known as “extensibility” of a manageable resource.

With reference to FIG. 1B, prior art proposals as implemented in the IBM product IBM Virtualization Engine Release 2, commercially available from IBM and offering WSDM services,

a) require that:
the resource (left column in table of CMDB 12) such that
i) the operating system in the above example,
   the “instrumented-by” relationship itself, and
   the instrumentation—the agent in the example—
   must be implemented as a WSDM Manageable Resource with its own persistency. Prior art also treats the underlying persistency as encapsulated.

Further, these prior art implementations require to have all participants of a relationship to be persisted, i.e., to store them persistently. This requires events, or time-based discovery cycles to scan the resources, extract the properties, see the right column of database 12 and store the property data in the data store 12. In each discovery cycle relevant data is discovered only once. Further, and disadvantageously, only quasi-constant data, such as a name or total storage space of a resource is persisted. Thus, any other access to additional properties such as dynamically changing data such as:

current workload,

current available storage space,

current CPU consumption,

current network load, etc,

of a resource is disadvantageously not possible in prior art.

In summary, prior art involves the following disadvantages:

First, and most important, the configuration database is only to a certain time consistent with the current state in the life cycle of a resource.

Second, due to this “static” nature of data stored in the configuration database, it makes no sense to store and make retrievable for a web service quickly changing, dynamic data such as CPU load, or other resource state information as such dynamic data cannot be replicated into the database because of the frequent changing nature of this dynamic data.

Third, no direct access to the resource is available.

### OBJECTIVES OF THE INVENTION

The objective of the present invention is thus to provide an improved method and system for an easier implementation of dynamic extensibility with instrumentation capabilities.

### SUMMARY OF THE INVENTION

This objective of the invention is achieved by the features stated in enclosed independent claims. Further advantageous arrangements and embodiments of the invention are set forth in the respective subclaims. Reference should now be made to the appended claims.

In short words, the present invention proposes a “lightweight”, i.e., a ready-to-use, comfortably usable implementation that uses the data in the configuration database and implements a “instrumentedBy” relationship within the same configuration database. This is a sharply contrasting feature relative to above prior art, which implements additional persistent data outside of such registry.

According to the broadest aspect of the present invention a method for performing systems management on IT-resources using web services, wherein the resources (10) are managed in a computational network within a plurality of runtime environments having different respective instrumentations, wherein the web services are implemented according to a public web service standard, e.g., WSDM, wherein a resource configuration database (12) is provided for storing a collection of resource-specific data on the IT-resources, characterized by the steps of:
a) server-side correlating the network address of a resource comprised of the network with a database entry provided within the configuration database for the resource,
b) wherein the correlation includes the definition of an instrumentation of the resource,
c) selecting the entry for automatically invoking the instrumentation of the resource,
d) accessing the resource via a web service by using the automatically invoked resource instrumentation.

By that the objective above is solved and the advantage results, that the client-side system management application can easily access a resource and retrieve respective resource properties because the correlation between database entry and the actual resources is done automatically at the server-side without manual interaction of an administration user. Thus, attributes and properties are transparent for a resource administration user.

In this situation a web service used for systems management purposes must be newly deployed under inclusion of the link established before.

It should be noted that a configuration database such as the CMDB is just an example for a configuration database that is used as a registry or inventory by systems management applications. Other types of registries, or inventories can also be used within the inventional method.

A preferred implementation includes the creation of a link from the data representation in the configuration database to the network address of a discovered WSDM manageable resource. This enables for direct access to a resource just by reading the configuration database entry of a resource, without to be constrained to check other data stores available in the network storing different properties of the resource, as this is the case in prior art.

Further, and even higher business value arises due to a preferred feature of the inventional method and system, when applying WSDM, or other web services standards used for systems management, for providing an integration of multiple domains to enable distributed management using a standard web service protocol.

In this context, multiple domains shall be understood to relate to different instrumentations such as “CIM-instrumented”, or “SNMP-instrumented”, or “JMX-instrumented”; further, this term means domains, i.e., storage locations, where cached copies of resources are held, such as registries or inventories. It should be noted that in prior art, a systems management application needs to support all such protocols in a distributed, heterogeneous environment. Applying the present invention allows to seamlessly add web services—e.g., WSDM—on top of these instrumentations and therefore enables much more simplified client access patterns.

By that the access of WSDM manageable resources (MRs) is made transparent for a systems management application such that the management application needs no specification making any distinction between cached data representations of a resource or an instrumented resource. According to this preferred aspect of the invention, the job of querying extension properties of a resource is facilitated by avoiding intensive instruction maintenance work and a long path length for specifying a resource.

According to this preferred aspect of the invention, the present invention proposes a method for performing systems management on IT-resources using web services. In particular, a single web service implementation is proposed which dynamically and automatically generates WSDLs for multiple resource type classes. This implementation is model-agnostic, as it doesn't require any knowledge about the underlying model—here the resource model—and uses introspection of the applied model at the time of invocation for the dynamic WSDL generation.

For example, the inventional method uses functionality in application programming interfaces (APIs) of instrumentations of resources, e.g., a Computer Information Model (CIM) or functionality of APIs in case of data representations in case of the presence of configuration databases such as CMDB. The inventional method may provide inventional services that can be used unchanged in a number of different environments (model agnostic). The implementation of a service provided by the inventional method is still conforming to industry standards, for example, a adhering to the WS-ResourceFramework specification.

According to this preferred aspect the inventional method further comprises the steps of:

a) using a stateless, generic web service for requesting descriptive information on the IT resources from respective database entries, wherein the descriptive information includes state information associated with a respective one of the resources,

b) wherein the information includes an enumeration of resource types used within the network, and

c) using the generic web service for requesting meta data describing different instances currently existing in the network for a given, pre-selected resource type comprised of the enumeration.

From this advanced method the additional advantage results that descriptive information on all resource instances is obtained at runtime without the necessity of programming a special web service which is specific for the different instances of a specific resource type. In presence of hundreds or thousands of different resource types and resource type specific instances the steps can be cast into two basic generic web services, which can be used instead of respective hundreds or thousands of web services as required in prior art. This descriptive information can be used for basic tasks of systems management. It can also be used for accessing a resource independent of the plurality of different, prevailing sub-standards.

A preferred variant of the inventional method having the latter aspect implemented comprises the stateless implementation of a web services access layer usable when a resource shall be accessed for monitoring purposes.

Then the further steps are implemented preferably in two additional web services:

a) using the before-mentioned generic web service for a request requesting information on resource-specific metadata indicating access rules required for accessing the resource,

b) receiving the metadata,

c) performing an access to the resource specifying the received metadata.

The state of the resource is maintained in the instrumentation of the resource. No additional persistence on top is implemented according to the invention. The stateful behavior as required by the WSDM and WS-Man standards is fully available for clients despite its stateless implementation. This enables advantageously to scale in large environments and provides high availability as the clients are not bound to a single resource instance.

It should be noted that a key capability of this aspect is that the inventional method does not perform a generic abstraction of multiple underlying interfaces to one generic interface. Instead, the inventionally provided web services—after having exploited the core feature of the additional “instrumented by” relationship in the configuration database—open up an interaction and collaboration at runtime, between the client occupied with systems management tasks and the resources, or a resource configuration database, during which interaction and collaboration multiple stages are run: in a first stage, a list of resource types is requested. In the second stage properties, operations, relationships, etc of resource instances are requested. In a third, optional stage driven by actual use cases, in which an actual access to a resource is desired, a meta data description of a resource instance is requested and delivered to the client. And in a last stage instance data are requested, which are required to access a particular resource.

### BRIEF DESCRIPTION OF THE DRAWINGS

The present invention is illustrated by way of example and is not limited by the shape of the figures of the drawings in which:

FIG. 1A illustrates the most basic structural components of a prior art hardware and software environment used for a prior art method,

FIG. 1B illustrates details in the database 12 of FIG. 1, (prior art),

FIG. 1C is a depiction according to FIG. 1B, illustrating a preferred implementation of a “instrumented by” relationship in a database entry of a resource according to a preferred embodiment of the present invention;

FIG. 2 illustrates the structural and functional components of a hardware and software environment used for a preferred web service based systems management method according to a preferred embodiment of the inventional method;

FIG. 3 illustrates the most basic functional components of a preferred embodiment of the inventional method in an overview, summary depiction;

FIG. 4 illustrates the most basic structural components of an inventional hardware and software environment used for a preferred embodiment of the inventional method in a view opposed to that of FIG. 1;

FIG. 5 illustrates an interaction diagram illustrating interaction of the most important steps of a preferred embodiment of the inventional method between the cooperating components;

FIG. 6 illustrates the most basic functional components of a preferred embodiment of the inventional method implementing WSDM Common Services;

FIG. 7 illustrates the most basic functional components of a preferred embodiment of the inventional method implementing WSDM Common Services for CIM instrumented resources;

FIG. 8 is a prior art depiction of a control flow/interaction diagram illustrating the request response scheme according to prior art,

FIG. 9 illustrates the control flow and interaction diagram according to an inventional embodiment, in which the systems management client uses a prior art typed management of resources and the server side (right column) is inventionally provided with a generic web service implementations,

FIG. 10 is a depiction according to FIG. 9, but also implementing generic definitions for the systems management client,

FIG. 11 is a schematic control flow diagram comprising the basic functional steps of the inventional method according to a preferred embodiment thereof, when performing the process of establishing the inventional “instrumented by”-relationship for a resource in a configuration database, and

FIG. 12 illustrates the most basic structural components of an inventional hardware and software environment used for a preferred embodiment of the inventional method in context of a use case of this method.

It is to be noted, however, that the appended drawings illustrate only example embodiments of the invention, and are therefore not considered limiting of its scope, for the invention may admit to other equally effective embodiments.

### DETAILED DESCRIPTION

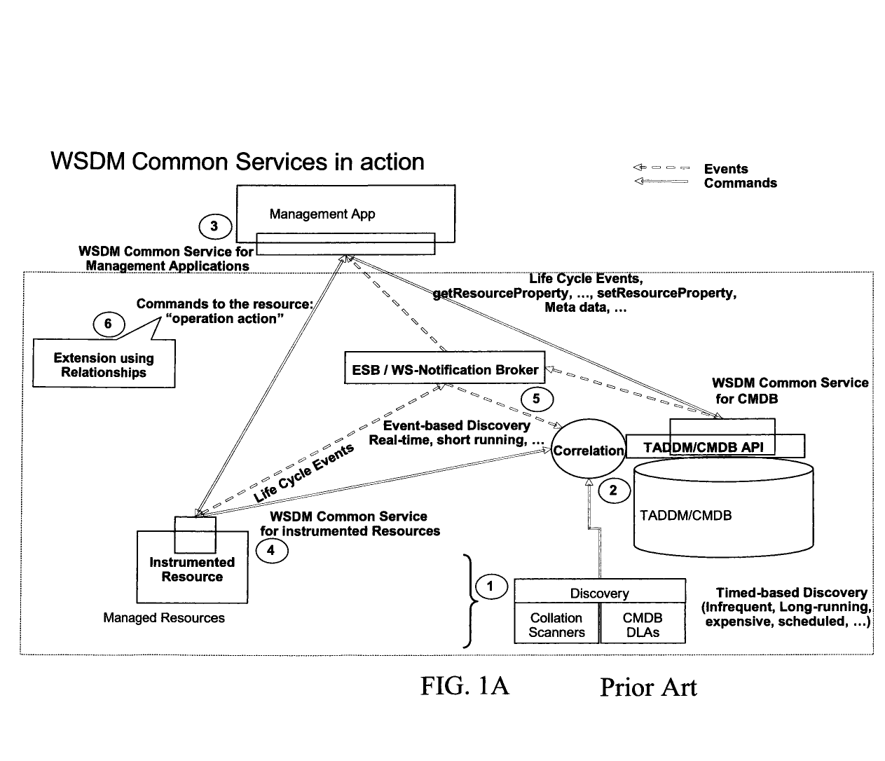

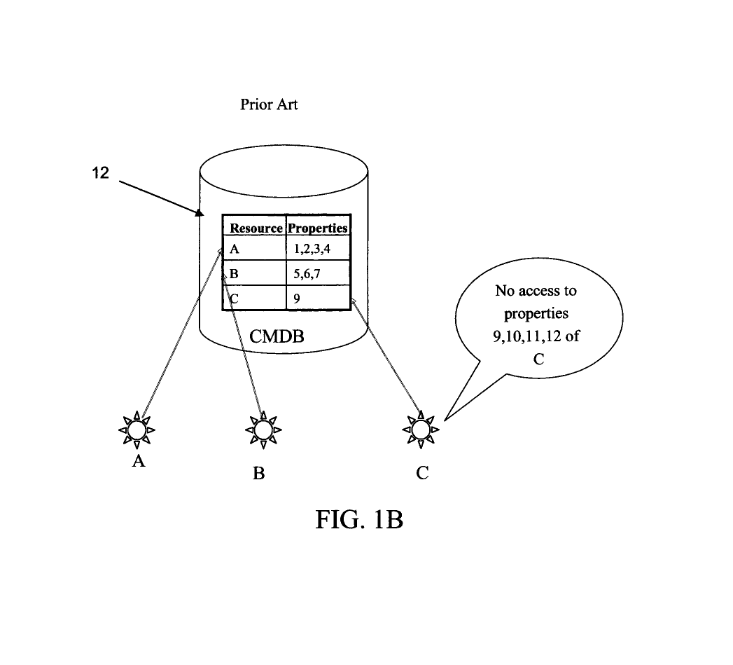

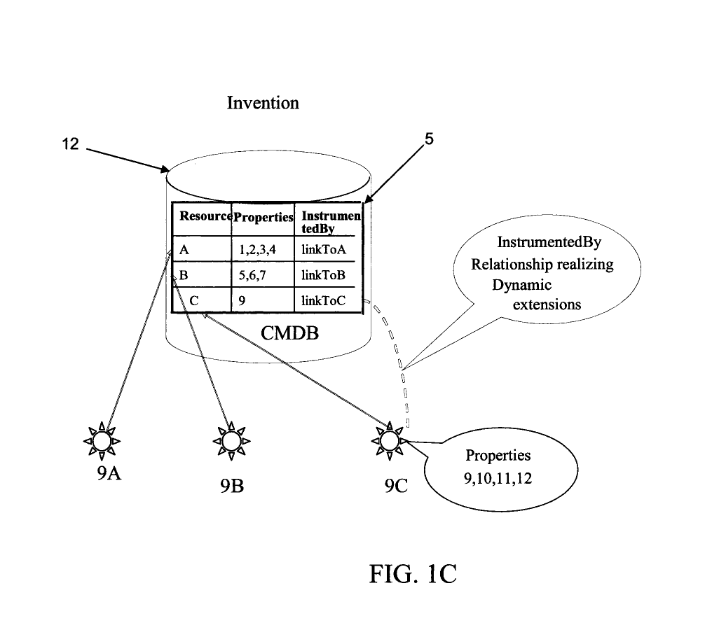

With general reference to the figures and with special reference now to FIG. 1C the database 12 is depicted to include an “instrumented-by”-relationship 5. In this embodiment the respective entry is provided for each resource. The entry comprises a link to the resource, preferably by storing the unique network address of this resource. This is done preferably for each resource stored in the configuration database 12. The benefit of it relative to prior art is that according to this invention no persistent data is stored outside of the configuration database 12. Of course, instead of a configuration database 12 a registry or an inventory can be used instead.

In this embodiment, an operating system 9C of a computer device is chosen as an example for a resource C. Preferably, the before-mentioned agents are installed on top of the operating system and constitute the instrumentation of a resource. Such agent can implement any operations with a resource, for example an agent may provide monitoring capabilities for monitoring a resource. An Endpoint Reference (EPR) is defined in prior art WS-Addressing and provides transport-neutral mechanisms to address Web services in networks. For example, the EPR of the WSDM Manageable Resource implementation of the installed Agent represents one of the instrumentations of the resource type “operating system”. In a concrete example, “operating system” is a resource type, and “LINUX SLES 9” can be a concrete resource, on which an agent is installed.

Preferably, the “instrumented-by”-relationship is created when a resource is discovered the first time, see resource C, for example. Then, the properties 10, 11, 12 can be accessed in addition to property 9. Thus, all properties and operations of the resource are accessible.

Shortly, the beneficial use of this relation 5 is as follows: Clients query the operating system 9C and retrieve properties from the operating system with all instrumentations included. By that, the client gets immediate access to all properties of the operating system 9C including its extensions which can be the EPR of the WSDM Manageable Resource represented by the Agent.

If changes of the resource configuration have happened in the course of some time, then the changes are re-deployed by re-deploying the services and WSDLs therefore, including a restart of the runtime application server. It should be noted that this is necessary only according to the basic aspect of the invention. According to a preferred aspect thereof using the generic web services, as it is described later below such re-deployment is not necessary anymore.

This inventional method introduces the extensibility of WSDM manageable resources with WSDM manageable resources instrumented fully transparent for systems management clients. Such management applications can directly access the resource by contacting the registry, which enables them to access also frequently changing data, i.e., life data, from the resource and/or to send pre-selectable commands to a resource.

This kind of extensibility is preferably dynamic. In other words during runtime an existing resource can be added to its data representation in the database. By that, the “real-life” relationship with the data representation is persisted.

For management applications different access scenarios are provided:

First, the client always retrieves the WSDM manageable resource data including all WSDM manageable resources. In particular, this is data related to the resource of which a respective data copy resides in the CMDB. The client gets the properties related to a resource, which properties can be accessed by the inventional “instrumented-by” relationship.

Here, a query topology depth one is proposed for all InstrumentedBy relationships.

Second, the client application subscribes to life cycle events emitted by the creation of the linkage. Whenever such events are received the client retrieves the meta-data of the extension.

Third, the client is subscribed to the topic “InterfaceModificationsEvent”. When the event is received the only thing a client needs to do is to retrieve the new meta-data of the WSDM manageable resource data. Again, this is data related to the resource of which a respective data copy resides in the CMDB. It contains then the aggregated portTypes of above data and the actual resource, which is accessible via the inventional “instrumented-by” relationship.

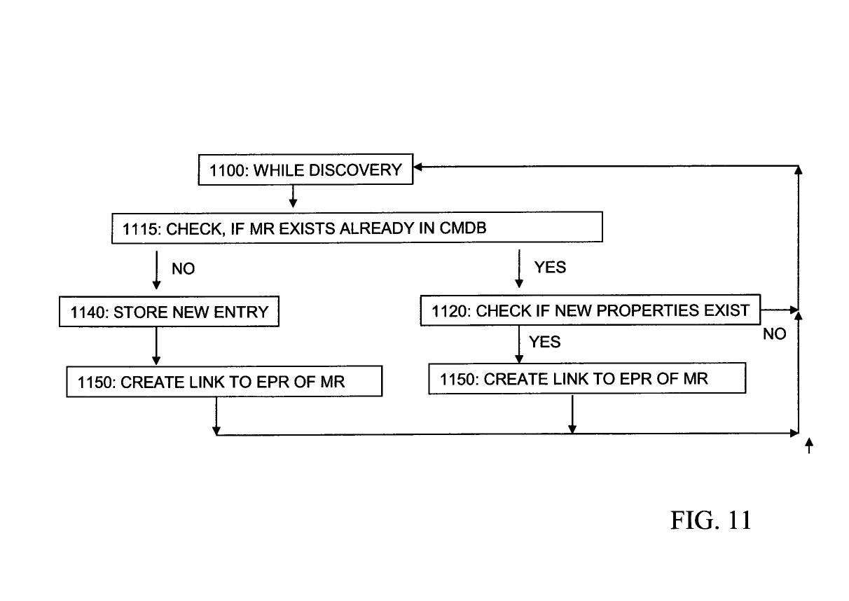

With further reference to FIG. 11 the process of establishing the before-mentioned “instrumented-by”-relationship is described in more detail. When a WSDM-manageable resource is discovered, either manually or when it advertises its existence using lifecycle events, a process is provided according to the invention, which executes the correlation of the data stored in the configuration database 12 with the discovered manageable resource, and which establishes the link 5 between the resource and the extensions.

In particular, during a discovery run 1100 the correlation component 15 checks in a step 15 if a newly advertised or discovered WSDM-manageable resource (MR) is equal to an already existing entry for a resource in the configuration database 12. This is preferably implemented by correlating properties with specific rules that allow concluding on identical entries. Normally, in the straight-forward case, the properties that are used to check for matching are identical when the resource models are the same. When the resource models differ, the rules that are to be applied should implement the following logic:

The standards specify the use of so called “correlatable properties”. They are used to define which properties, or combinations of properties of the different models can be used to identify uniqueness. For example it can define that the property “IP_Address” in model B equals network_address in model A.

In the YES-branch of step 1115 a newly found operating system may be assumed to be found as an example of a WSDM-manageable resource, having an installed agent on top. In particular, a next check-step 1120 checks, if new properties of this manageable resource which are not available yet in the configuration database 12 are available or not. If not, control is branched back to step 1100. In the YES-branch of decision 1120 the proposed instrumented-by-relationship is created by using a link to the EPR of the WSDM-manageable resource (MR). By that step 1150 the full set of properties, i. e., those already available in the configuration database, which properties are mostly the immutable ones, and the additional ones received from the agent, are available for systems management application clients.

In the NO-branch of decision 1115 an entry of the discovered WSDM-manageable resource is not yet existing in the configuration database. Thus, in a step 1140 a respective new entry is created storing at least the properties of the resource in a step 1140 and creating a link to the EPR of the manageable resource in a subsequent step.

A client systems management application may access the manageable resource basically again using three different scenarios, which differ in the way the client application deals with the instrumented-by-relationships:

First, the client always retrieves the WSDM-manageable resource including all extensions by applying a query topology depth “1” for all instrumented-by-relationships.

Second, the client subscribes to instrumented-by-relationships lifecycle events. In this case the client has subscribed to events that are published to the notification broker whenever a instrumented-by-relationship has been added, updated, or deleted. Whenever such events are received, the client retrieves the metadata of the extension. Extension in this case means any related property or properties linked to the WSDM-manageable resource using the instrumented-by-relationship. As the client is using the WS Common services to access the WSDM manageable resources he is immediately able to retrieve the updated properties even if dynamic updates have been done. This is described in more detail in the copending patent application “Single Service Implementation of WSDL generation of Multiple Resource Type Classes”, filed by the Applicant.

Third, the client obligation is subscribed to the topic “interface modification event”. As stated earlier, implementers of the WS management standards such as WSDM can specify topics in a notification broker and then publish life cycle events to this broker. In this access pattern they publish events to the topic “interface modification event” which enables all subscribed clients to react on such events.

When the event is received, the only thing a client application needs to do is to retrieve the new metadata of the manageable resource. It contains then the aggregated portTypes of the resource and the agent.

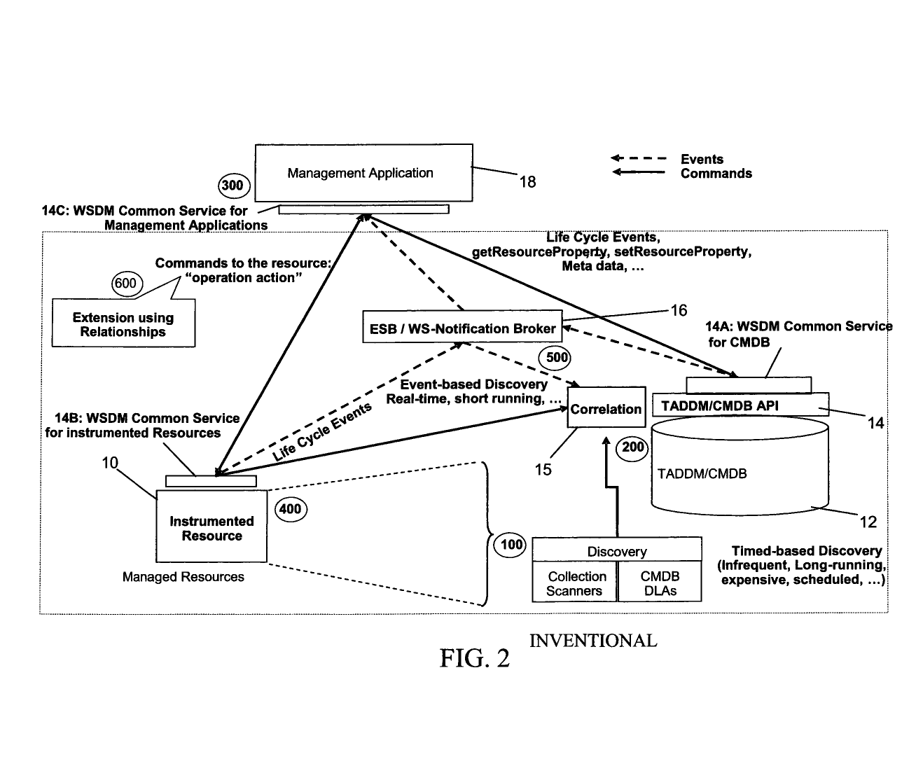

With special reference now back to FIG. 2 to 10, a preferred embodiment of the invention is described in more detail.

According to FIG. 2 the main components of the present invention are WSDM-enabled instrumented resources 10, a configuration database 12 used as a registry that has WSDM interfaces 14, a message infrastructure enabled by a notification broker 16 to support handlings of events, and a systems management application 18 exploiting WSDM.

Reference is made to the following interaction steps 100 to 600:

Step 1 00: Time-based discovery gathers information about network attached IT-resources and stores it in a configuration database 12, for example in a TADDM (Tivoli Application Distributed Discovery Manager (TADDM)/Configuration Management Database (CMDB). Typically, the discovery processes are long-running, scheduled activities that require a lot of compute resources. According to the invention this needs to be done only once for resources with WSDM enablement and WSDM discovery. In prior art this must be done repeatedly.

Step 200: Multiple discovery runs performed by prior art systems management application require a correlation component 15 ensuring that new data is inserted, or already existing data is updated.

Step 300: Systems management applications 1 query Meta data (Web Services Description Language (WSDL), RMD, RPD), enumerate CMDB classes, enumerate instances of a particular class and follow the relationships of the respective entities. They access entries in database 12 as WSDM manageable resources. They can subscribe to events issued by the database 12 to the Notification Broker 16. To do this using WSDM, is enabled by using a small set of generic web services referred to in here as “WSDM common services” (WSDM CS). Prior art offers no generic web services.

Step 400: Resources with applied instrumentation capabilities such as Computer Information Model (CIM), Simple Network Management Protocol (SNMP), or Java Management Extension (JMX) are WSDM-enabled and thus usable for web service based system management by using a set of web services called “WSDM CS” for instrumented Resources. Details how these services work using a generalized proxy pattern, are given further below. These resources emit life cycle events such as “resource created” or “resource destroyed” to the notification broker 16. This provides for the ability for short-running, real-time discovery as well as other capabilities such as providing data to subscribers that are not stored in the configuration database 12. Typically, this would be monitoring dynamic data like CPU load, number and type of active operating system processes, and the like.

Step 500: When it is assumed that such an IT Resource advertises it's presence in the network through a life cycle event, the correlation component 15 needs to check, if the data representation of the resource is already in the database, because it is found earlier by, for example, time-based discovery runs.

Thus, the correlation component 15 is required in order to correlate existing entries with newly discovered ones. Further, the correlation task is extended in order to cope with:

a) WSDM enabled resources which have advertised life cycle events, and

b) resources discovered with prior art mechanisms.

If an entry is not yet present, an entry is created in the database 12. In both cases a relationship is established in the database that links the data entry with the Instrumented Resource. This enables clients to query the data representation and get access to the associated instrumented resources as well.

Multiple such relationships can be associated to the data entry.

The complexity of the correlation functionality varies with the underlying models of the instrumented resources and the representation in the database 12. The straightforward case is, if both have the same underlying model. In case they differ, policies need to be defined to allow identifying if the data representation in the database 12 is the one representing the instrumented resource.

Step 600: Then it is possible to actually do systems management with the instrumented resource for example, by issuing a command to the resource.

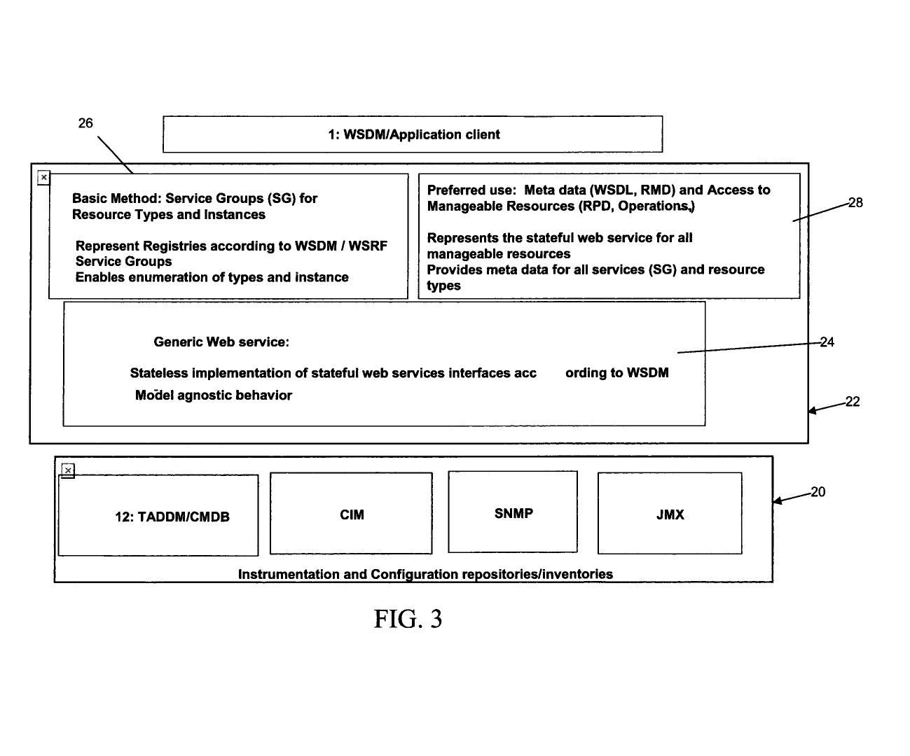

With reference to FIG. 3 an overview diagram is given illustrating the basic inventional system.

Included in a bottom layer 20, typical elements used in prior art of systems management are shown. Inventories, also known as registries are realized by systems management products itself e.g., IBM Director, TPM, or they use configuration databases such as TADDM/CMDB and instrumentation technologies such as CIM, SNMP, JMX. These instrumentation sources or repositories keep all information of IT-resources like configuration parameters and state.

In the middle layer 22, the inventional method is roughly illustrated in an overview form.

Block 24 depicts general functionality thereof: the usage of a core pattern that is used to implement generic web services as described further above. The web services according to the invention use the stateless implementation of stateful interfaces of web services according to WS standards as well as an inherent model agnostic behavior.

In order to access an IT-resource, two additional web services depicted in box 28 are provided according to the invention:

One additional web service is used to retrieve meta-data from the available services and the available resource types. In the case of using web service standards for management this meta-data is the WSDL and the RMD.

The second additional web service is a web service implementation which in turn plays the role of each web service which is “virtualizing” the resource using web services. In WSDM terminology this is the WSDM manageable resource.

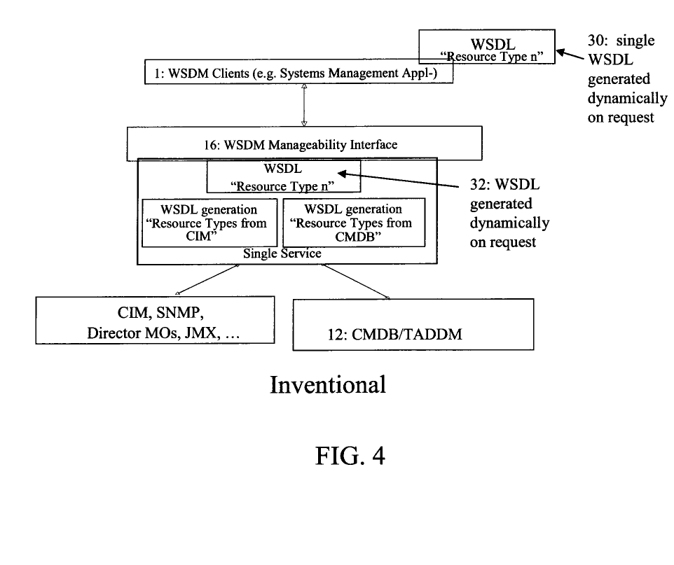

FIG. 4 is an overview diagram illustrating the inventional architecture as opposed to FIG. 1. A single generic web service creates a single WSDL 30. Separate functional control software generates the WSDL for all resource types from CIM, whereas another separate unit generates the WSDLs for resources, the types of which are stored in the configuration database 12 referred to in here as CMDB.

As opposed to the prior art it is clear to a person skilled in the art that from a client perspective a significant simplification is achieved over prior art by the inventional method, as only one WSDL is required to deal with all resource types. Remark, that in prior art this was a number about 1000.

On the web service implementation side the architecture is simplified also. A single service 32 provides responses to client requests with dynamically generated payload.

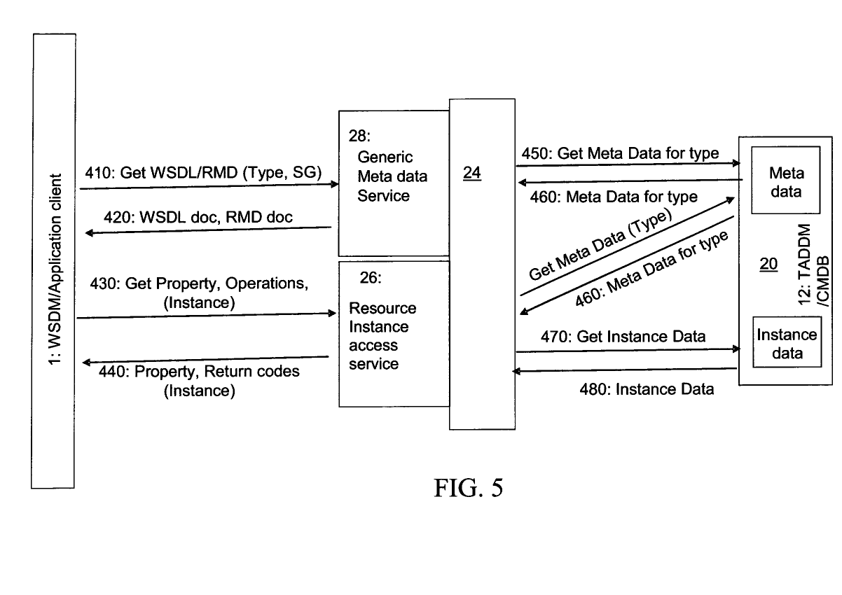

With reference to FIG. 5 more details are given outlining how a WSDM client is provided with meta-data for a particular resource type using the inventional, generic implementation of a meta-data service. The boxes correspond to that of FIG. 3. In this case the meta-data service plays the role of a meta-data service for that particular type and retrieves the appropriate information from the configuration database 12. According the WSDM standard specification, the WSDL and the RMD are returned to the WSDM client 10.

Remark that in prior art a resource property is requested on a resource ID. Then the type of the resource is looked up locally, to pick the correct WSDL interface definition. Then, a web service is called to request the respective resource property document. According to the invention the resource property is requested on a resource ID. Then the inventional generic web service is called with the resource ID to get a dynamically generated WSDL. Then a web service is called to request the resource property document.

Properties and operations of WSDM Manageable Resources are then accessed or executed using the retrieved meta-data and the second web service 26 labeled “Resource Instance Access Service”.

In more detail, according to this embodiment a first request is sent 410 from client 1 to the inventional meta data service 28.

This is a request requesting for the WSDL or the RMD of a certain resource type or Service Group. This request is serviced by the inventional metadata service 28 producing a response 420 comprising an automatically generated WSDL document or/and an automatically generated resource metadata document (RMD).

The component 24 provides the generic capabilities described above with reference to FIG. 3 to the services 28 and 26.

Then, in a next request 430 client 10 requests the properties or operations and other system attributes for a certain instance of one type of resources specified in request answer 420. Then, the resource instance access service 26 fulfills the request using the component 24 and gets the meta data 460 of the requested type by querying the configuration database 12 of layer 20. With the enriched request information a new request 470 is issued to the configuration database 12 of layer 20 and the Instance data is returned 480.

The response 440 to the client 1 is fulfilled with the help of the responses 460 and 480.

In a concrete use case according to FIG. 5, the client application 1 may be assumed to access a property of a specific Operating System (OS), namely the Vendor Name thereof. It queries two registries with WSDM compliant requests (QueryResourceProperty), step 430, to finally get the EndPointReference (ERP) of the Operating System instance, step 480, which is then accessed using the WS common service with a WSDM compliant GetResourceProperty request.

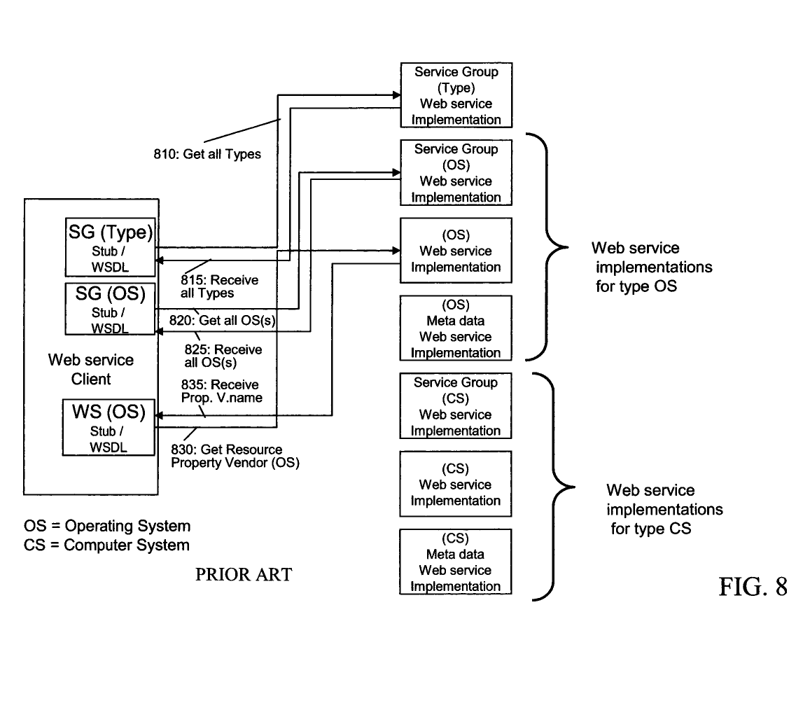

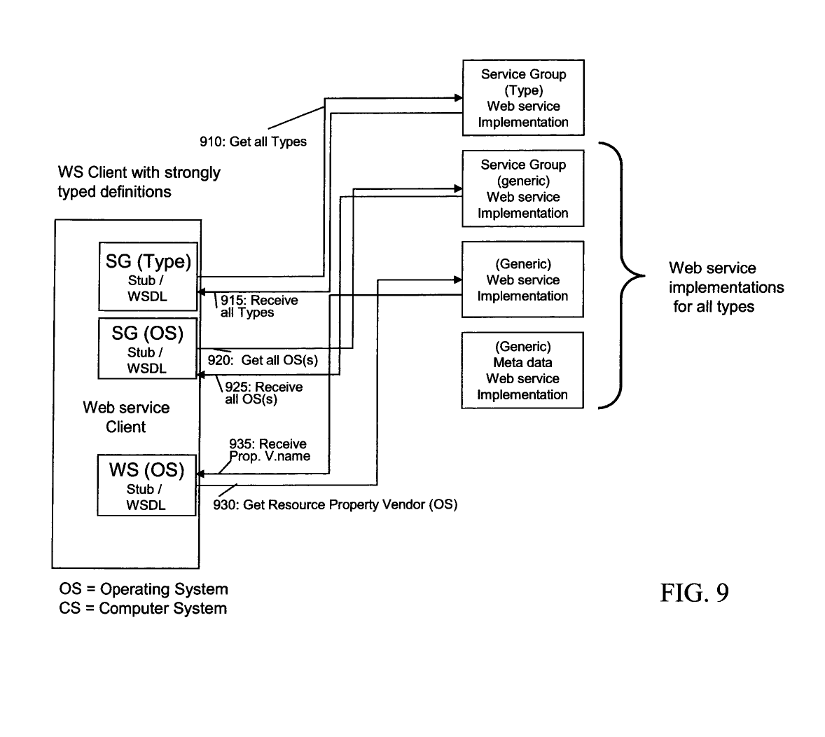

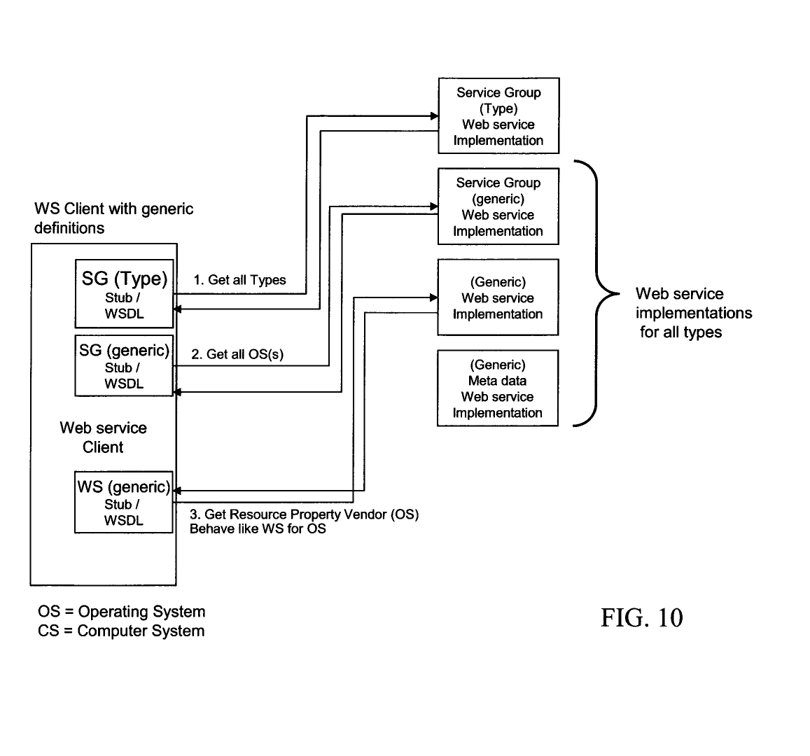

This example is detailed in the FIGS. 8, 9 and 10 where the prior art access pattern is shown in FIG. 8 for the purpose of improved clarity, ready to be compared with preferred embodiments of the inventional method depicted in FIGS. 9 and 10:

FIG. 8 is a prior art depiction of a control flow/interaction diagram illustrating the request response scheme according to prior art,

In FIG. 8 prior art queries the Service Group to get all resource types, see step 810. After having received them, step 815, the client requests all Operating System (OS) instances from the Service Group implementation for Operating Systems, see step 820. After having received them, step 825, with one of the OS instances the OS service is accessed, see step 830 to retrieve the property “vendor name”, see step 835. Remark, that disadvantageously, for all types that the prior art system supports it needs respective web service implementations, see all boxes in the upper part of the right column. In FIG. 8, the resource type “Computer System” (CS) is shown as a second type, see bottom part of right box column.

FIG. 9 illustrates the control flow and interaction diagram according to an inventional embodiment, in which the systems management client uses a prior art typed management of resources and the server side (right column) is inventionally provided with a generic web service implementations, and FIG. 9 shows the same access pattern using a preferred embodiment of the invention, see steps 910 to 935, which correspond to steps 810, . . . 835. The type specific web service implementations, see the right column of boxes, are replaced according to the invention by the generic implementations of the invention. The generic implementations behave like the type with which the client is requesting the service. Note, that FIG. 9 shows a client using strongly typed web service definitions. This is an option that can be used by client applications that e.g., want to deal with an entitled set of types.

FIG. 10 is a depiction according to FIG. 9, but also implementing generic definitions for the systems management client. In a variant of FIG. 9 a generic client can access all types supported by the generic service implementations.

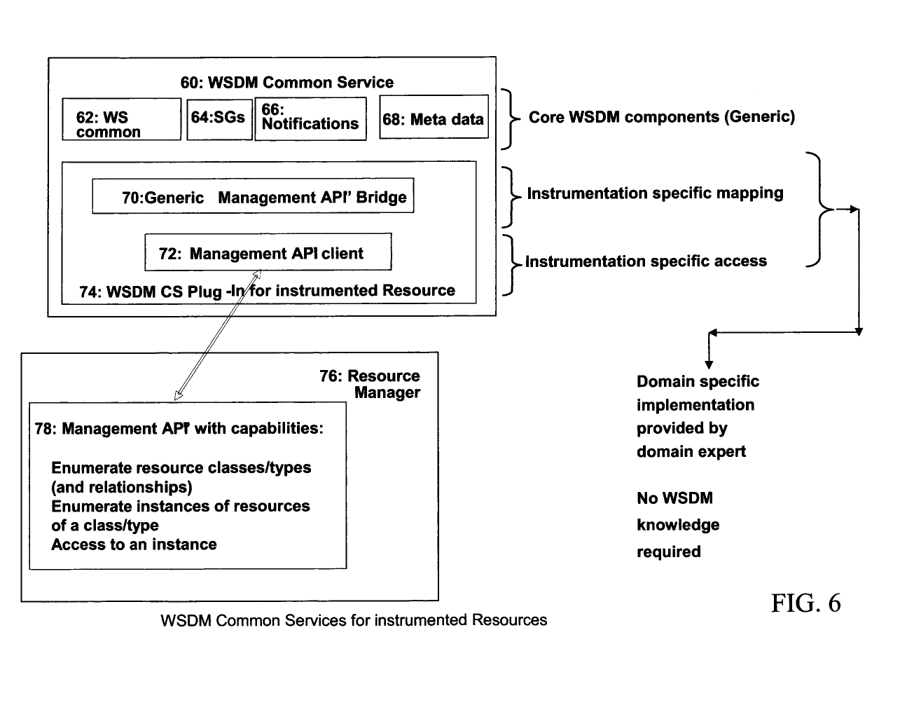

Next, and with reference back to FIG. 6, some details of a preferred implementation of the preferred embodiment are given in relation to WSDM CS and instrumented Resources.

The prior art WSDM Common Services (CS) components can be advantageously used for inventories and/or registries that maintain copies of data of “real” IT resources as well as for IT resources with instrumentations such as the before-mentioned CIM, SNMP, or JMX.

In order to use the WSDM CS components in a systems management environment using web services this is very important, because registries/inventories only store data of IT resources that are either immutable (e.g., the MAC address), or very infrequently changed after they have been discovered (e.g., the hostname, the IP Address, or the Vendor Name). It should be noted that in prior art systems management frequently changing data for purposes of monitoring, such as CPU load, or even operations/commands are not available from inventories or registries.

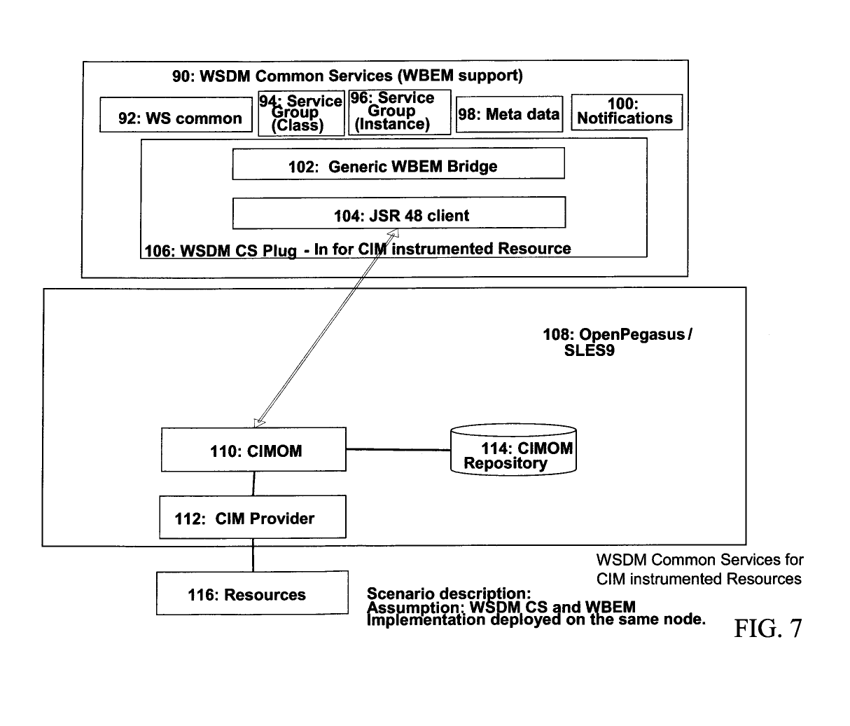

In FIGS. 6 and 7 details are illustrated disclosing how WSDM CS is applied to instrumented resources in general; a specific implementation is selected for CIM:

FIG. 6 shows the components of the small set 60 of generic web services referred to in here as “WSDM common services” (WSDM CS). Its layers are separated in core web services components, instrumentation specific mapping and instrumentation specific access. All instrumentation specific components are implemented using a respective plug-in 74. It is made up of a client 72 to the management API of the resource manager 76, e.g., a WBEM client and a bridge that maps requests from the web services components 62, 64, 66, and 68 to the instrumentation specific management API. The “WS common” component 62 is the generic service that handles all access to the resource. Component 64 is made up of two services that are a Service Group for enumeration of types and an enumeration of instances for a specific type. Notifications about Life Cycle Events (created, destroyed, updates, . . . ) are provided, or emitted using component 66. The meta data service 68 provides meta data artifacts such as WSDLs and RMDs.

FIG. 6 further depicts the Resource Manager 76 (e.g., CIMOM, or TADDM) containing respective programmed capabilities to:

1. Enumerate resource classes or types and relationships,

2. Enumerate instances of resources of a class/type,

3. Allow access to an instance.

Usually these capabilities are provided by an application programming interface (API) or by a command line interface.

In FIG. 7 an example for a concrete implementation of the scheme in FIG. 6 is given. The web services components 92, 94, 96, 98, 100 are never changed. For the WBEM/CIM support 90 the plug-in 106 is implemented using the generic bridge 102 and the appropriate JSR 48 client. The later communicates with the CIMOM 110 of the OpenPegasus implementation available with the Linux operating system SLES9, see reference 108. The component 114 provides the persistence capability of CIM where a CIM Provider 112 deals with the actual resources 116.

A person skilled in the art may appreciate, that the following advantages can be achieved by applying the inventional method:

The extensibility of WSDM manageable resources (data) with WSDM manageable resources (instrumented) is fully transparent for clients;

The access to extension properties can easily be federated;

The inventional method allows for incremental adoption of Web service representation of resources;

The inventional method is flexible for data model movement due to factoring decisions;

The direct access to the resource enables to access life data from the resource and/or send commands to the resource;

The extensibility can be dynamic. In other words during runtime an existing resource can be added to the data representation in the database;

Persistence of the real-life correlation with the data representation;

The inventional method encapsulates the access to multiple resources into web services and thus eliminates the need to perform multiple tasks with most likely different protocols in order to perform systems management with resources. A significant simplification of workflows and activities results compared to prior art. Prior art requires to query to have much more semantics (“How do I access the agent”, or “which parameters are needed to call this API of the agent”, or “What context needs to be passed to the next activity”, etc) in the client.

An important use case for applying the inventional method is to apply it in data centers. Data centers provide a large plurality of resources of any type offering these resources to interested users such as enterprises.

Typically a system's administrator in a data center aims always to be aware of when and which discovered resources are being managed. In this preferred application of the inventional method WSDM is introduced to management applications which perform a manually control of lifecycle activities of resources.

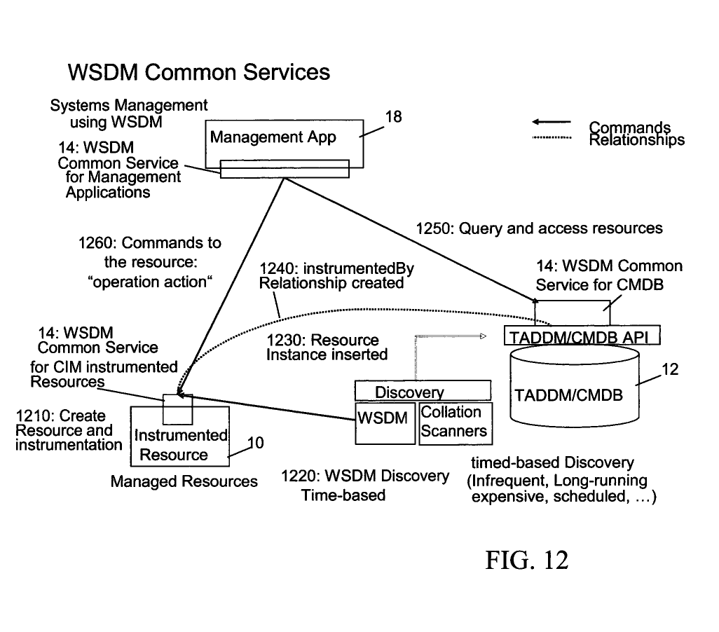

FIG. 12 has a structure similar to that of FIG. 2 and illustrates this important use case.

In this particular use case the configuration database 12 is an IBM TADDM/CMDB database acting as the master of persisted data. A management application 18 will always query this database 12 first, using the WSDM-case abilities as introduced with reference to FIGS. 2 to 10. None-WSDM-enabled resources 10 are discovered using software provided along with the configuration database product, indicated in FIG. 12 by the so-called “time based, long running scans”.

Preferably, when database vendors have enabled their instrumented resources with WSDM-CIM, then the following scenarios are advantageously possible:

The WSDM-CIM instrumented resource 10 is created (e.g., an Agent is installed), step 1210.

The WSDM Time-based discovery component is started, step 1220.

The WSDM-CIM instrumented resource is discovered and inserted into the database 12, TADDM/CMDB, step 1230.

The data representing the discovered resource 10 is linked by adding a “instrumentedBy” Relationship to the WSDM-CIM instrumented resource, step 1240.

The Systems Management Application 18 is enabled to query, step 1250, and access the resource data and instrumentation using WSDM interfaces, step 1260. All the configuration data stored in CMDB can be accessed using WSDM interfaces 14. This includes access to related instrumented WSDM Manageable Resources.

Management actions can be directly sent to the WSDM-CIM instrumented resource 10, step 1260.

A person skilled in the art will appreciate that the above task-oriented scenarios can be further extended with options such as presenting the discovered WSDM-enabled resources to the administrator who then may commit which resource shall be included in the configuration database 12.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The invention claimed is:

1. A method for performing systems management on IT-resources using web services, wherein the resources are managed in a computational network within a plurality of runtime environments having different respective instrumentations, wherein the web services are implemented according to a public web service standard, wherein a resource configuration database is provided for storing a collection of resource-specific data on said IT-resources, the method comprising the steps of:
server-side correlating the network address of a resource comprised of said network with a database entry provided within said configuration database for said resource, wherein said correlation includes the definition of an instrumentation of said resource,
selecting said entry for automatically invoking the instrumentation of said resource,
accessing said resource via a web service by using said automatically invoked resource instrumentation.

2. The method according to claim 1, wherein the step of correlation includes storing a link within said database entry pointing to the network address of said resource.

3. The method according to claim 1, further comprising the steps of:
utilizing a stateless, first generic web service for requesting descriptive information on said IT resources from respective database entries, wherein said descriptive information includes state information associated with a respective one of said resources, wherein said information includes an enumeration of resource types used within said network,
utilizing a second generic web service for requesting meta data describing different instances currently existing in the network for a given, pre-selected resource type comprised of said enumeration,
and wherein said resource is managed in a computational network within a plurality of runtime environments having different respective instrumentations.

4. The method according to claim 3, further comprising the steps of:
utilizing said first generic web service for a request requesting information on resource-specific metadata indicating access information required for accessing said resource,
receiving said metadata,
performing an access to said resource specifying said received metadata.

5. A computer system for performing systems management on IT-resources using web services, wherein the resources are managed in a computational network within a plurality of runtime environments having different respective instrumentations, wherein the web services are implemented according to a public web service standard, wherein a resource configuration database is provided for storing a collection of resource-specific data on said IT-resources, characterized by
means for server-side correlating the network address of a resource comprised of said network with a database entry provided within said configuration database for said resource, wherein said correlation includes the definition of an instrumentation of said resource,
means for selecting said entry for automatically invoking the instrumentation of said resource,
means for accessing said resource via a web service by using said automatically invoked resource instrumentation.

6. The computer system according to claim 5, further comprising:
a stateless, first generic web service for requesting descriptive information on said IT resources from respective database entries, wherein said descriptive information includes state information associated with a respective one of said resources, wherein said information includes an enumeration of resource types used within said network,
a second generic web service for requesting meta data describing different instances currently existing in the network for a given, pre-selected resource type comprised of said enumeration,
and wherein said resource is managed in a computational network within a plurality of runtime environments having different respective instrumentations.

7. A computer program product for performing systems management on IT-resources using web services, wherein the resources are managed in a computational network within a plurality of runtime environments having different respective instrumentations, wherein the web services are implemented according to a public web service standard, wherein a resource configuration database is provided for storing a collection of resource-specific data on said IT-resources wherein said product is stored on a computer usable medium comprising computer readable program means including a functional component for causing a computer to perform the steps of:
server-side correlating the network address of a resource comprised of said network with a database entry provided within said configuration database for said resource, wherein said correlation includes the definition of an instrumentation of said resource,
selecting said entry for automatically invoking the instrumentation of said resource,
accessing said resource via a web service by using said automatically invoked resource instrumentation,
and wherein said computer program product is executed on a computer.

8. The computer program product according to claim 7, wherein the step of correlation includes storing a link within said database entry pointing to the network address of said resource.

9. The computer program product according to claim 8, wherein said computer readable program means including a functional component further perform the steps of:
utilizing a stateless, first generic web service for requesting descriptive information on said IT resources from respective database entries, wherein said descriptive information includes state information associated with a respective one of said resources, wherein said information includes an enumeration of resource types used within said network,
utilizing a second generic web service for requesting meta data describing different instances currently existing in the network for a given, pre-selected resource type comprised of said enumeration,
and wherein said resource is managed in a computational network within a plurality of runtime environments having different respective instrumentations.

10. The computer program product according to claim 9, wherein said computer readable program means including a functional component further perform the steps of:
utilizing said first generic web service for a request requesting information on resource-specific metadata indicating access information required for accessing said resource,
receiving said metadata,
performing an access to said resource specifying said received metadata.
